(19) United States
(12) Patent Application Publication
(10) Pub. No.: US 2018/0140151 A1
(43) Pub. Date: May 24, 2018

(54) Wipers cleaning head system and method

(71) Applicant: Aviram Mann, Mordii'n (IL)

(72) Inventor: Aviram Mann, Mordii'n (IL)

(21) Appl. No.: 15/355,080

(22) Filed: Nov. 18, 2016

(51) Int. Cl. A47L 11/30; A47L 11/38; A47L 11/40; H02S 40/10

(52) U.S. Cl. CPC A47L 11/307; A47L 11/38; A47L 11/4088; A47L 11/4044; A47L 11/4011; H02S 40/10; A47L 11/4041; A47L 11/4055; A47L 11/4066; A47L 11/4069; A47L 11/4013

(57) ABSTRACT

The present invention provides a cleaning apparatus head for cleaning surfaces such as windows, solar panels, floors, walls Etc.

The cleaning head facilitates rapid and uninterrupted cleaning work on the subject surfaces. The cleaning process incorporates scraping dirt by applying a wet sponge, as well as the disposal of grime by means of suction pump.

The cleaning apparatus comprised of: a carrier for moving the cleaning head along the surface, a main body for holding the cleaning head parts, at least two wipers, movable forwards and backwards towards the surface, a sponge element located at the front of the main body, in between the two wipers, at least two movable arms for pushing and pulling the wipers by pistons and an electronic controller programmed for controlling the pistons movement, according to the cleaning head's movement direction.

### FIELD OF THE INVENTION

The present invention relates generally to methods and systems for cleaning smooth surfaces, and surfaces having protruding elements such as window frames and more specifically to methods and cleaning head having two wipers and a sponge.

### BACKGROUND OF THE INVENTION

There is a need for cleaning large surfaces, such as windows of buildings or solar panels. Today most cleaning operations are preformed manually, by human workers.

The cleaning head apparatus as suggested by the present invention is intended for continuously cleaning surfaces such as windows, floors or solar panels in horizontal or vertical orientation. Known in the art are cleaning heads using brushes wet or dry sponges.

The cleaning head is designed to be connected to a carrier unit that moves the cleaning head apparatus along a surface.

### SUMMARY OF THE INVENTION

The present invention provides a cleaning apparatus head for cleaning surfaces, said cleaning apparatus comprised of:
at least one motor for moving the cleaning head along the surface;
a main body for holding the cleaning head parts;
at least two wipers, movable along axis forward and backwards along the surface;
a sponge element located at the front of the main body, in between the two wipers;
at least two movable arms for pushing and pulling the wipers;
an electronic controller, programmed for controlling the movable arm according to the cleaning head's movement direction;
wherein at each stage of the cleaning process only one wiper is located at the front of the cleaning head in contact with the surface.

According to some embodiments of the present invention, the electronic controller is programmed for controlling the movable arms, such that when the cleaning head is moved in the left direction, the wiper located on the right side of the sponge element is moved forward, towards the surface, and the wiper located on the left side is removed backwards, away from the surface. In a complementary manner, when the cleaning head is moved in the right direction, the wiper located on the left side of the sponge element is moved forward, towards the surface, and the wiper located on the right side is removed backwards, away from the surface.

According to some embodiments of the present invention the cleaning head is mounted on a moving platform, which is mounted on a track, located on a transporter moving along the cleaning surface, wherein the cleaning head can move forward and backward from the cleaning surface.

According to some embodiments of the present invention, the cleaning head is moving on a platform which has at least one engine for moving the track.

According to some embodiments of the present invention, the cleaning head further comprises a wetting element for wetting the sponge.

The present invention provides a wiping apparatus for cleaning surfaces, said apparatus being movable along the surface to be cleaned by a moving mechanism operatively connected thereto, said wiping apparatus comprising:
an applicator for applying cleaning material onto the surface to be cleaned;
at least two wipers, each wiper located at a different side of said applicator such that said applicator is positioned between said wipers;
at least one shifting mechanism, operatively associated with said wipers, said shilling mechanism being configured for moving a one wiper away from the surface, at each given wiping movement of the apparatus, while the other wiper is maintained in contact with the surface being cleaned, depending on direction of the wiping movement of said wiping apparatus.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a pictorial illustration showing cleaning head according to some embodiments of the present invention.

FIG. 2 is a pictorial illustration showing cleaning systems integrated with the cleaning head, according to some embodiments of the present invention.

FIG. 3 is a pictorial illustration showing suction element, according to some embodiments of the present invention.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

a. The present invention provides a wiping apparatus for cleaning surfaces, said apparatus being movable along the surface to be cleaned by a moving mechanism operatively connected thereto, said wiping apparatus comprising:
b. an applicator/sponge for applying cleaning material onto the surface to be cleaned;
c. at least two wipers; each wiper located at a different side of said applicator/sponge such that said applicator is positioned between said wipers;
d. at least one shifting mechanism operatively associated with said wipers, said shifting mechanism being configured for moving one wiper away from the surface, at each given wiping movement of the apparatus, while the other wiper is maintained in contact with the surface being cleaned, depending on direction of the wiping movement of said wiping apparatus.
e. The cleaning head further comprises a wetting element on the sponge and a suction device for removing the dirt and water-detergent from wipers.

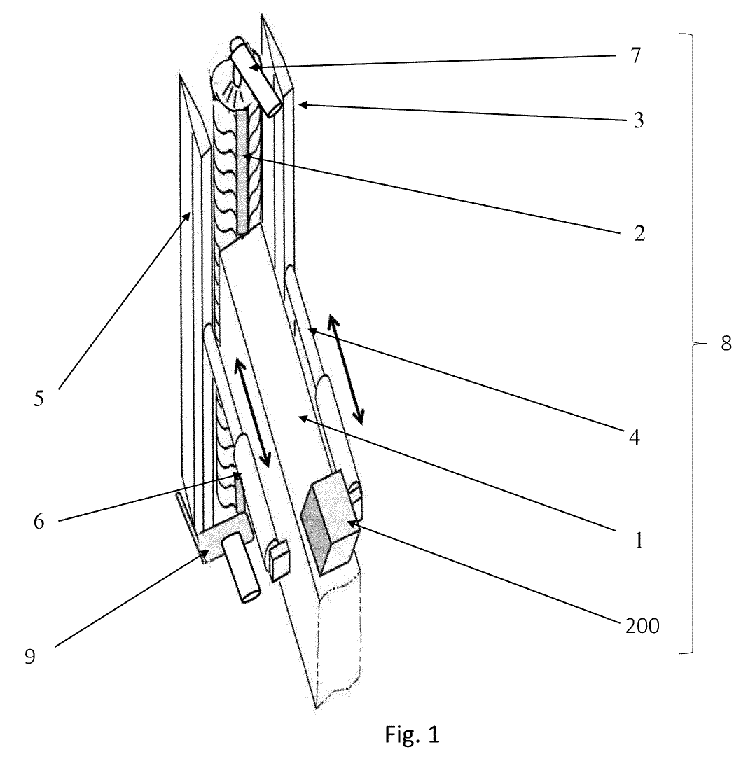

FIG. 1 is a pictorial illustration showing the cleaning head according to some embodiments of the present invention. A main bar 1 holds the entire contraption together. A wet sponge 2 connected to the front of the bar 1, is responsible for moisturizing the surface (such as: window, floor, wall or solar panel) scraping and melting any dirt or debris. A right wiper element 3 wipes the liquid and dirt and cleans the window when the contraption moves to the left. A transporter/piston 4 moves the right wiper element 3 towards and away from the surface, so that the wiper touches the window while it wipes it. A left wiper element 5 wipes the liquid, dirt and cleans the window when the contraption moves to the right. A transporter/piston 6 moves the left wiper 5 towards and away from the window, so that the wiper element touches the window while it wipes it. The movement of the pistons 4 and 6 are controlled by an electronic controller 200, programmed to move the piston forward or backwards according the cleaning head 8 movement direction in the horizontal vertical or inclined axis.

The cleaning head may further include a wetting element 7 on the top of the sponge 2 and a suction element 9, e.g. for removing fluid and dirt which has accumulated at the lower edge of the wipers.

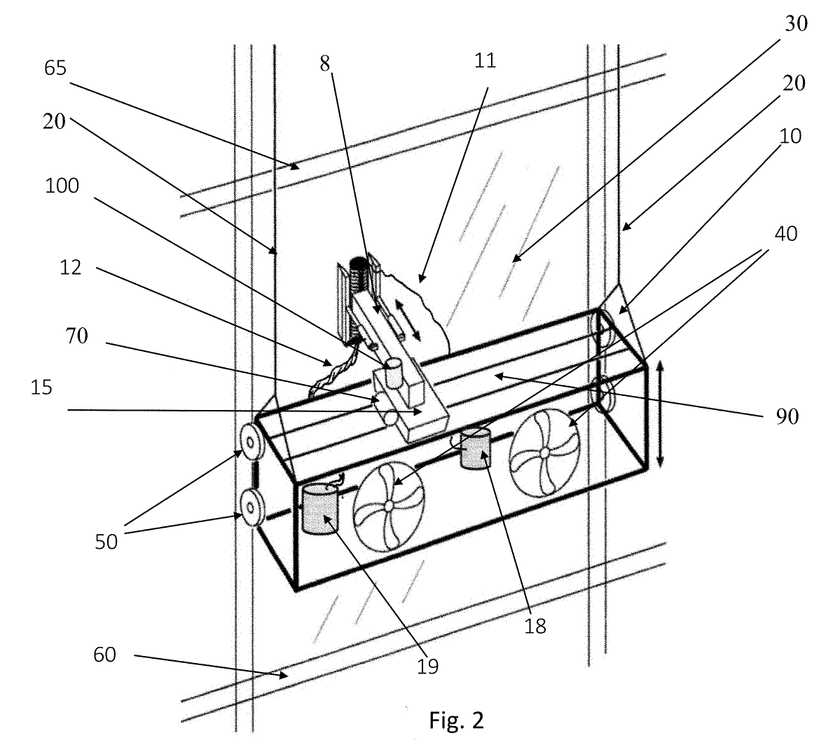

FIG. 2 is a pictorial illustration showing the cleaning head integrated with an operating system according to some embodiments of the present invention. The cleaning head 8 is installed on carrier 10 having moving platform 15 for cleaning surface 30, said moving platform 15, which operated by motor 70, is moving to the left and right on track 90 located on the upper surface of the carrier 10. The cleaning head 8 is further controlled by engine 100, for moving forward and backward on the moving platform when required to overcome an obstacle such as the frame 65 or 60 between surfaces. The carrier 10 moves up and down, hanging on cables 20, stretching from a crane mounted on the roof of the building for moving the cables. The fans 40 stabile the carrier near the building. The wheels 50 stabilize the movement of the carrier along the surface

The cleaning head may further include:

a wetting element (as seen in FIG. 1 number 7) on the top of the sponge 2 which connects through pipe 11 to a container with a pump 18 for providing liquid for the wetting element.

A suction element (as seen in FIG. 1 number 9) is connected by pipe 12 to a vacuum device 19 for collecting the waste by the suction element for removing fluid and dirt which has accumulated at the lower edge of the wipers 3,5 and the sponge 2.

According to some embodiments, more than one cleaning head is installed and operates on the same carrier.

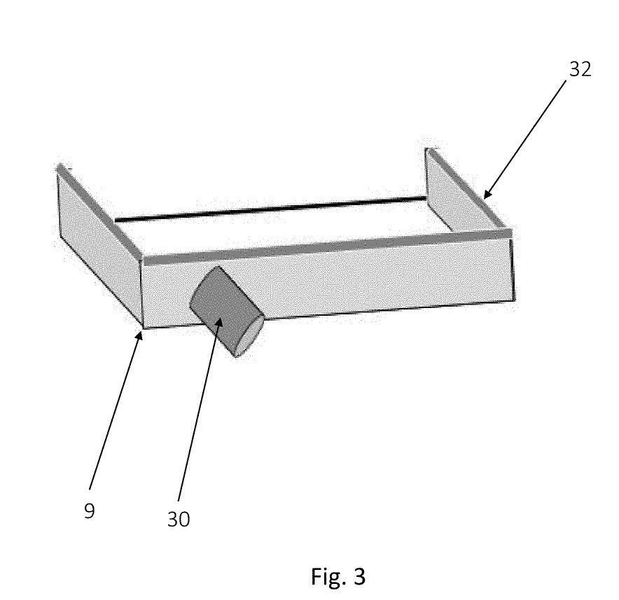

FIG. 3 is a pictorial illustration showing the suction element 9, according to some embodiments of the present invention. The suction element 9 is comprised of a pipe interface 30 and a part 32 having a drawer shape designed for collecting the dirt from the two wipers and the sponge.

The present invention provides a cleaning apparatus head for cleaning surface. The cleaning apparatus is comprised of: a main body for holding the cleaning head parts, at least two wipers movable along a horizontal or vertical axis forward and backwards towards the surface, a sponge element located at the front of the main body, in between the two wipers, at least two movable arms (such as pistons or arms operated by engine) for pushing and pulling the wipers.

The pistons' movement is controlled, such that when the cleaning head is moving to the left, the wiper located on the right side of the sponge element is moved forwards toward the surface and the left wipers moves backwards from the surface, and when the cleaning head is moving to the right, the wiper located at the left side of the sponge element is moved forwards toward the surface and the right wiper moves backward. At each state of the cleaning only one wiper is located at the front of the cleaning head in contact with the surface.

The references cited herein teach many principles that are applicable to the present invention. Therefore the full contents of these publications are incorporated by reference herein where appropriate for teachings of additional or alternative details, features and/or technical background.

It should be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended.

What is claimed is:

1. A cleaning apparatus head for cleaning surfaces associated with a cleaning system, said cleaning apparatus comprised of:
A main body for holding the cleaning head parts;
At least two wipers for wiping liquid and dirt from the surface, movable along an axis forward and backwards toward the surface;
a sponge element located on the front side of the main body for wiping, scraping and cleaning the dirt, in between the two wipers;
at least two movable arms for pushing and pulling the wipers;
an electronic controller, programmed to control the movable arms' movement, according to the cleaning head movement direction;
wherein at each stage of the cleaning process only one wiper is located at the front of the cleaning head in contact with the surface;

2. The cleaning head of claim 1 wherein the electronic controller is programmed to control the movable arms' movement, such that when the cleaning head is initiates movement in the left direction, the wiper located on the right side of the sponge element is moved forward, towards the surface, and the left wiper is moved backwards, way from the surface, and when the cleaning head initiates movement in the right direction, the wiper located on the left side of the sponge element is moved forward, towards the surface, and the right wiper is moved backwards, away from the surface.

3. The cleaning head of claim 1, wherein the electronic controller is programmed such that when the cleaning head initiates movement in one direction, the wiper located on one side in relation to the sponge is moved forward, toward the surface, said side direction in relation to the sponge is opposite to the cleaning head moving direction.

4. The cleaning head of claim 1 wherein the cleaning head is mounted on a moving platform which is mounted on a track located on a carrier moving along a surface, wherein the cleaning head can move forward and backwards from the cleaning surface.

5. The cleaning head of claim 4 wherein the cleaning head has at least one motor for moving forward and backward from the cleaning surface.

6. The cleaning head of claim 4 wherein the moving platform has at least one motor for moving the head along the track.

7. The cleaning head of claim 1 further comprising wetting element for wetting the sponge.

8. The cleaning head of claim 1 further comprising suction element for collecting fluid and dirt from the wiper.

9. The cleaning head of claim 1 wherein the movable arms are pistons.

10. The cleaning head of claim 1 can be configured to move along vertical, horizontal or inclined surface.

11. A wiping apparatus for cleaning surfaces, said apparatus being movable along the surface to be cleaned by a moving mechanism operatively connected thereto, said wiping apparatus comprising:
a. an applicator for applying cleaning material onto the surface to be cleaned;
b. at least two wipers, each wiper located on a different side of said applicator such that said applicator is positioned between said wipers;
c. at least one shifting mechanism operatively associated with said wipers, said shifting mechanism being configured for moving one wiper away from the surface, at each given wiping movement of the apparatus, while the other wiper is maintained in contact with the surface being cleaned, depending on the direction of the wiping movement of said wiping apparatus.
